(19) United States
(12) Patent Application Publication
(10) Pub. No.: US 2025/0256142 A1
(43) Pub. Date: Aug. 14, 2025

(54) BATTERY THERMAL EVENT DETECTION AND SUPPRESSION

(71) Applicant: CPS Technology Holdings LLC, New York, NY (US)

(72) Inventor: David R. BOONE, Waukesha, WI (US)

(21) Appl. No.: 18/856,985

(22) PCT Filed: Apr. 21, 2023
(86) PCT No.: PCT/US2023/019374

§ 371 Date: Oct. 15, 2024

Related U.S. Application Data
(60) Provisional application No. 63/333,410, filed on Apr. 21, 2022.
(60) Provisional application No. 63/333,441, filed on Apr. 21, 2022.

(51) Int. Cl. A62C 35/13; A62C 3/16; H01M 10/42; H01M 10/48; H01M 50/682

(52) U.S. Cl. CPC A62C 35/13; A62C 3/16; H01M 10/425; H01M 10/486; H01M 50/682

(57) ABSTRACT

A suppression system is described. The suppression system includes a container having an internal space arranged to receive a battery, and an event monitor. The container includes one or more bags that include a suppression material. The one or more bags are arranged to discharge the suppression material at least to the internal space of the container based on one or more parameters and one or more control signals. The discharged suppression material is usable to control a battery event. The event monitor includes one or more sensors configured to measure the one or more parameters, which are transmittable by the event monitor to a monitoring device and trigger the one or more control signals.

### TECHNICAL FIELD

This disclosure relates to batteries and in particular to event detection, alerting and suppression in batteries such as, for example, Lithium-Ion (Li-Ion) batteries.

### BACKGROUND

Batteries are an essential part of many devices, including motor vehicles. Historically, motor vehicles were equipped with a single battery, e.g., a lead acid battery, used to both start the vehicle's motor as well as to power the other systems of the vehicle, e.g., charging system, operation while running, lighting, accessories, etc. More recently, electric vehicles and hybrid gasoline/electric vehicles (collectively referred to herein as electric vehicles or EVs), rely on one or more Li-Ion batteries to provide energy to power electric motors that cause the vehicle's wheels to move and to also power the other systems of the vehicle. While batteries such as Li-Ion batteries provide large storage and powering capacities, some battery technologies, such as Li-Ion batteries, are susceptible scenarios that result in rapidly escalating internal thermal temperatures, sometimes referred to as “thermal runaway”. This condition occurs when the amount of heat generated by a battery exceeds the amount of heat that can be dissipated to the surroundings. As the battery heats, the situation worsens and accelerates. This can be a result of poor cooling, improper charging, battery failure and/or damage. Failure to detect such thermal runaway conditions can lead to fire, explosion and other undesirable consequences.

Of particular concern is the situation where a Li-Ion battery in a vehicle experiences a thermal runaway condition. In this scenario, the driver may not know that the condition is occurring, and driving under such conditions can lead to an accident if a battery or batteries catch fire, explode, etc. Similarly, a Li-Ion battery powered vehicle that is in an accident can have a battery damaged during the accident, leading to a thermal runaway condition and possible fire or explosion.

As another example, a battery may need to be shipped from one location to another, such as for recycling, new installation, etc. In such cases, failure to detect and address a thermal event, such as a thermal runaway event, can be dangerous and lead to injury of those involved with the shipping and/or damage to the shipping company's equipment.

### SUMMARY

Some embodiments advantageously provide a method and system for detecting a thermal event, such as a thermal runaway event, alerting the occurrence of the event and/or then initiating one or more actions to suppress the thermal event.

According to one aspect, a suppression system is described. The suppression system includes a container having an internal space arranged to receive a battery, and an event monitor. The container includes one or more bags that include a suppression material. The one or more bags are arranged to discharge the suppression material at least to the internal space of the container based on one or more parameters and one or more control signals. The discharged suppression material is usable to control a battery event. The event monitor includes one or more sensors configured to measure the one or more parameters, which are transmittable by the event monitor to a monitoring device and trigger the one or more control signals.

In some embodiments, the one or more bags comprise one or both of a first bag and a second bag. The one or more parameters comprise a first parameter, and the container comprises a valve coupled to the first bag and configured to open when the first parameter reaches or exceeds a first parameter threshold to discharge the suppression material of the first bag. The one or more parameters comprise a second parameter, and the container comprises a pin arranged to puncture the second bag when the second parameter reaches or exceeds a second parameter threshold to discharge the suppression material of the second bag.

In some other embodiments, the suppression material of the first bag and the second bag are discharged during a first discharge stage and a second discharge stage, respectively, based on the one or more parameters.

In some embodiments, one or more of the valve is configured to receive a first control signal of the one or more control signals that triggers the valve to open to discharge the suppression material of the first bag; the opening of the valve is associated with a first exposure period in which the discharged suppression material is exposed to the battery; the pin is configured receive a second control signal of the one or more control signals that triggers the pin to puncture the second bag to discharge the suppression material of the second bag; and the puncturing of the second bag is associated with a second exposure period in which the discharged suppression material is exposed to the battery.

In some other embodiments, the container comprises an exhaust port arranged to receive a third control signal of the one or more control signals that triggers the exhaust port to control a release of the discharged suppression material from the internal space. The release of the discharged suppression material is controlled by one or more of opening the exhaust port, closing the exhaust port, throttling the exhaust port based on the one or more parameters.

In some embodiments, the controlling of the release of the discharged suppression material by the exhaust port controls a third exposure period in which the discharged suppression material is exposed to the battery.

In some other embodiments, the suppression system further comprises first processing circuitry and a first communication interface. One or both of the first processing circuitry is configured to determine the one or more control signals based on the one or more parameters, and the first communication interface is configured to receive the one or more control signals based on the one or more parameters.

In some embodiments, the event monitor further comprises a second communication interface configured to transmit the measured one or more parameters. The transmission of the measured one or more parameters triggers transmission of the one or more control signals.

In some other embodiments, the suppression material is arranged to flow through the internal space and absorb heat from one or more of the battery, the internal space, and the container.

In some embodiments, one or more of the one or more parameters include one or more of a battery temperature, a pressure associated with the internal space, and a presence of the suppression material; the battery event is a thermal runaway event; and the discharged suppression material controls the thermal runaway event.

According to another aspect, a system comprising a suppression system, an event monitor, and a monitoring device. The suppression system includes a container having an internal space arranged to receive a battery. The container includes one or more bags including a suppression material. The one or more bags are arranged to discharge the suppression material at least to the internal space of the container based on one or more parameters and one or more control signals. The discharged suppression material is usable to control a battery event. The event monitor includes one or more sensors configured to measure the one or more parameters. The measured one or more parameters are transmittable by the event monitor to the monitoring device and triggering the one or more control signals. The monitoring device is in communication with the event monitor and includes a user interface configured to display the one or more parameters.

In some embodiments, on or more of the suppression system comprises first processing circuitry configured to trigger the discharge of the suppression material of at least one of the one or more bags; the event monitor comprises second processing circuitry in communication with the one or more sensors and is configured to cause transmission of a message comprising the one or more parameters to the monitoring device; the monitoring device comprises third processing circuitry configured to one or more of receive the message; determine the battery event has occurred or a likelihood that the event will occur within a predetermined period of time based on one or both of the one or more parameters and a differential of the one or more parameters; and cause transmission of the one or more control signals to the suppression system to trigger the discharge of the suppression material of at least one of the one or more bags based on the determination that the battery event has occurred or the likelihood that the event will occur within the predetermined period of time. In some other embodiments, the one or more bags comprise one or both of a first bag, where the one or more parameters comprise a first parameter, and the container comprises a valve coupled to the first bag and configured to open when the first parameter reaches or exceeds a first parameter threshold to discharge the suppression material of the first bag; and a second bag. The one or more parameters comprise a second parameter, and the container comprises a pin arranged to puncture the second bag when the second parameter reaches or exceeds a second parameter threshold to discharge the suppression material of the second bag.

In some embodiments, the suppression material of the first bag and the second bag are discharged during a first discharge stage and a second discharge stage, respectively, based on the one or more parameters.

In some other embodiments, one or more of the valve is configured to receive a first control signal of the one or more control signals that triggers the valve to open to discharge the suppression material of the first bag; the opening of the valve is associated with a first exposure period in which the discharged suppression material is exposed to the battery; the pin is configured receive a second control signal of the one or more control signals that triggers the pin to puncture the second bag to discharge the suppression material of the second bag; and the puncturing of the second bag is associated with a second exposure period in which the discharged suppression material is exposed to the battery.

In some embodiments, the container comprises an exhaust port arranged to receive a third control signal of the one or more control signals that triggers the exhaust port to control a release of the discharged suppression material from the internal space. The release of the discharged suppression material is controlled by one or more of opening the exhaust port, closing the exhaust port, throttling the exhaust port based on the one or more parameters.

In some other embodiments, the controlling of the release of the discharged suppression material by the exhaust port controls a third exposure period in which the discharged suppression material is exposed to the battery.

In some embodiments, the suppression material is arranged to flow through the internal space and absorb heat from one or more of the battery, the internal space, and the container.

In some other embodiments, the system further comprises a fan configured to receive a fourth control signal of the one or more control signals, and the third processing circuitry is further configured to cause transmission of the fourth control signal triggering the fan to be energized and to extract discharged suppression material from the system.

In some embodiments, one or more of the one or more parameters include one or more of a battery temperature, a pressure associated with the internal space, a presence of the suppression material; the battery event is a thermal runaway event; and the discharged suppression material controls the thermal runaway event at least by causing the battery temperature to be less than a predetermined temperature threshold.

According to an aspect, a method in a system comprising a container, one or more bags, and a monitoring device is described. The container comprises an internal space and being arranged to receive a battery in the internal space and the one or more bags. The one or more bags comprise a suppression material usable for controlling a battery event. The monitoring device comprises a user interface. The method comprises measuring one or more parameters associated with the battery, transmitting the one or more parameters for displaying in the user interface, and triggering a discharge of the suppression material at least to the internal space of the container based on the one or more parameters and one or more control signals.

In some embodiments, the method further comprises transmitting a message comprising the one or more parameters to the monitoring device; determining the battery event has occurred or a likelihood that the event will occur within a predetermined period of time based on one or both of the one or more parameters and a differential of the one or more parameters; and receiving from the monitoring device the one or more control signals to trigger the discharge of the suppression material of at least one of the one or more bags based on the determination that the battery event has occurred or the likelihood that the event will occur within the predetermined period of time.

In some other embodiments, the one or more bags comprise one or both of a first bag and a second bag. The one or more parameters comprise a first parameter and a second parameter. The container comprises one or both of a valve coupled to the first bag and a pin arranged to puncture the second bag. The method further comprises one or both of opening the valve when the first parameter reaches or exceeds a first parameter threshold to discharge the suppression material of the first bag and puncturing the second bag when the second parameter reaches or exceeds a second parameter threshold to discharge the suppression material of the second bag.

In some embodiments, the method comprises discharging the suppression material of the first bag and the second bag during a first discharge stage and a second discharge stage, respectively, based on the one or more parameters.

In some other embodiments, one or more of the method further comprises receiving a first control signal of the one or more control signals, opening the valve to discharge the suppression material of the first bag based on the first control signal, receiving a second control signal of the one or more control signals, and triggering the pin to puncture the second bag to discharge the suppression material of the second bag based on the second control signal; the opening of the valve is associated with a first exposure period in which the discharged suppression material is exposed to the battery; and the puncturing of the second bag is associated with a second exposure period in which the discharged suppression material is exposed to the battery.

In some embodiments, the container comprises an exhaust port arranged to receive a third control signal of the one or more control signals, and the method further comprises receiving a third control signal and triggering the exhaust port to control a release of the discharged suppression material from the internal space based on the third control signal. The release of the discharged suppression material is controlled by one or more of opening the exhaust port, closing the exhaust port, throttling the exhaust port based on the one or more parameters.

In some other embodiments, the controlling of the release of the discharged suppression material by the exhaust port controls a third exposure period in which the discharged suppression material is exposed to the battery.

In some embodiments, the suppression material is arranged to flow through the internal space and absorb heat from one or more of the battery, the internal space, and the container.

In some other embodiments, the system further comprises a fan configured to receive a fourth control signal of the one or more control signals, and the method further comprises transmitting the fourth control signal and energizing the fan based on the fourth control signal to extract the discharged suppression material from the system.

In some embodiments one or more of the one or more parameters include one or more of a battery temperature, a pressure associated with the internal space, a presence of the suppression material; the battery event is a thermal runaway event; and the discharged suppression material controls the thermal runaway event at least by causing the battery temperature to be less than a predetermined temperature threshold.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of an example system constructed in accordance with the principles of present disclosure;

FIG. 2 is another block diagram of the example system constructed in accordance with the principles of present disclosure;

FIG. 3 is a suppression system comprising a container constructed in accordance with the principles of present disclosure;

FIG. 4 is an example system constructed in accordance with the principles of present disclosure; and

FIG. 5 is a flowchart of an example process in accordance with the principles of present disclosure.

### DETAILED DESCRIPTION

Before describing in detail exemplary embodiments, it is noted that the embodiments reside primarily in combinations of apparatus components and processing steps related to a battery event (e.g., thermal event) monitoring, detection and suppression system. In some embodiments, the system is implemented with one or more Li-Ion batteries, although embodiments are not limited solely to Li-Ion batteries. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

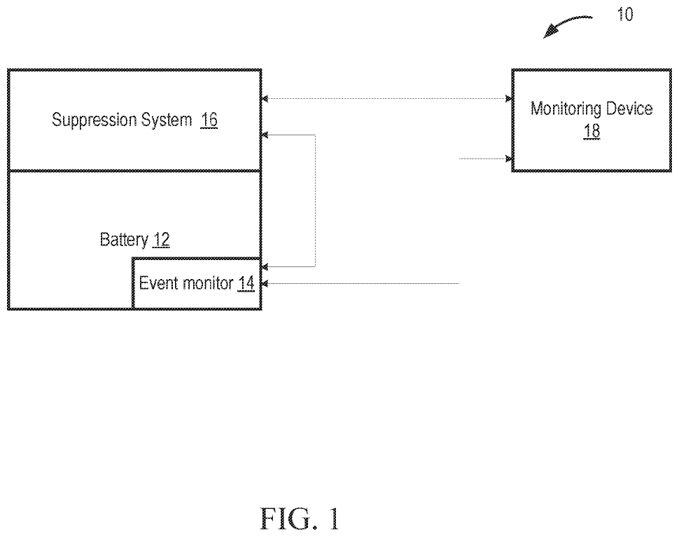

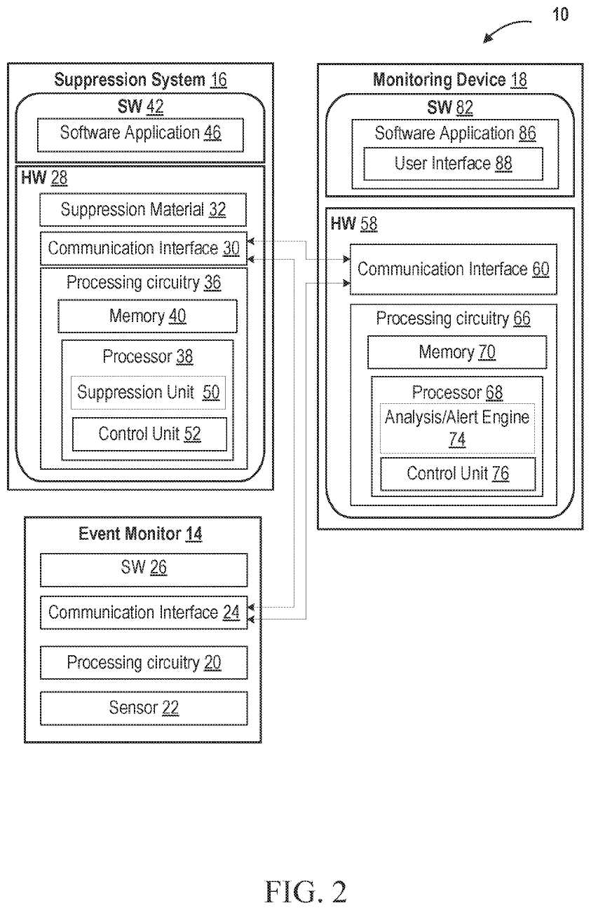

Referring now to the drawing figures in which like reference numbers refer to like elements, there is shown in FIGS. 1 and 2, a battery thermal event monitoring, detection and suppression system 10 constructed in accordance with the principles of the present disclosure. In some embodiments, system 10 may include a battery 12, for example a Li-Ion battery, which includes an event monitor 14 . . . . A suppression system 16 is coupled to, or in proximity to one or more batteries 12 such that the suppression system 16 can thermally suppress a thermal event in battery 12 when triggered. Although only one suppression system 16 and one battery 12 are shown, it is understood that more than one battery 12 and suppression system 16 can be implemented. Event monitor 14 may be in proximity to, within, or coupled to suppression system 16 (e.g., a container of suppression system 16). Further, system 10 may also include one or more monitoring devices 18.

Monitoring device 18 is in communication with event monitor 14 and/or suppression system 16. In some embodiments the communication is wireless and may be based on a known wireless communication protocol such as Wi-Fi, cellular, BLUETOOTH, and the like.

In some embodiments, battery 12 (having event monitor 14) and suppression system 16 may be included in (or include) a single package, e.g., shipping box, such as a shipping box used to ship the battery 12 to a recycling center. Such a box may be shipped empty to the person who is going to return the battery 12 for recycling. For example, the outbound box may include the suppression system 16 and an internal space to put the battery 12 into the box such that, when the box is sealed, the suppression system 16 ends up in contact with or in close enough proximity to battery 12 to allow suppression system 16 to address a detected thermal event in battery 12.

In operation, a driver of the shipping vehicle or an operator associated with the shipping company may use monitoring device 18 to be alerted of an event associated with a battery 12 being monitored by an event monitor 14. If a predetermined parameter threshold (e.g., temperate threshold) is reached, monitoring device 18 can alert the user and/or trigger suppression system 16 to activate in order to perform one or more actions (e.g., cool battery 12). Suppression system 16 can cool battery 12 via technologies such as dispensing cooling and/or fire suppression chemicals, cooled air, and the like. In some embodiments, the suppression system 16 may be arranged to suppress thermal events for Li-Ion batteries of up to 2.5 kWh or more.

FIG. 2 is a more detailed block diagram of the elements of FIG. 1. The system 10 includes an event monitor 14, suppression system 16 and monitoring device 18. In some embodiments, event monitor 14 may be incorporated within or affixed to battery 12 and/or suppression system 16. Although one of each element is shown, it is understood that more than one of each element can be implemented. An event monitor 14 can be formed as an integrated circuit and or small package and implemented to monitor one or more components (e.g., cells) of battery 12. Event monitor 14 may include processing circuitry 20, sensor 22, communication interface 24 and software 26. The processing circuitry 20 may include a processor and a memory (not shown). In particular, in addition to or instead of a processor, such as a central processing unit, and memory, the processing circuitry 20 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor may be configured to access (e.g., write to and/or read from) the memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory may be configured as a storage device.

Event monitor 14 may include a sensor 22 or other device used to measure one or more parameters. For example, sensor 22 may be a temperature sensor configured to measure temperature (e.g., of battery 12, or of a portion of battery 12 such as a battery cell, exhaust of the battery 12, etc.), a pressure sensor to measure pressure (e.g., to detect a pressure increase as a result of a discharge of suppression material 32), a suppression material detection sensor configured to detect presence of a material (e.g., to detect that the material has been discharged), or any other kind of sensor. Sensor 22 can be periodically read by processing circuitry 20. Event monitor 14 may include communication interface 24 enabling it to communicate directly/indirectly with any component/device of system 10. For example, communication interface 24 may be configured for setting up and maintaining at least a wireless/wired connection with any component/device of system 10 such as suppression system 16 and/or monitoring device 18. The communication interface 30 may be formed as or may include, for example, one or more RF transmitters, one or more RF receivers, and/or one or more RF transceivers.

Event monitor 14 further has software 26 (which may include a software application) stored internally in, for example, memory. Software 26 may include any software/program configured to perform the steps/processes of the present disclosure, e.g., measuring temperature and reporting the temperature to monitoring device 18 and/or triggering suppression system 16. In some embodiments, the event monitor 14 can have a predetermined maximum temperature or rate of temperature increase at which event monitor 14 may itself trigger (directly, or indirectly) suppression system 16 to cool battery 12.

The processing circuitry 20 may be configured to control any of methods and/or processes described herein and/or to cause such methods, and/or processes to be performed, e.g., by event monitor 14. The memory is configured to store data and/or files such as thermal data and/or other information/data described herein. In some embodiments, the software 26 may include instructions that, when executed by the processing circuitry 20, causes the processor and/or processing circuitry 20 to perform the processes described herein with respect to premises event monitor 14.

The system 10 further includes suppression system 16 including hardware 28. The hardware 28 may include suppression material 32 and processing circuitry 36. Suppression material 32 may be any chemical or arrangement that can be used to actively cool battery 12 when dispensed/discharged and/or is exposed to (e.g., comes in contact with, is in proximity to) the battery during an exposure period (i.e., a time duration in which the suppression material is exposed to the battery 12). The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory 40 may be configured as a storage device.

Hardware 28 of suppression system 16 may include communication interface 30 enabling it to communicate directly/indirectly with any component/device of system 10. For example, communication interface 30 may be configured for setting up and maintaining at least a wireless/wired connection with any component/device of system 10 such as event monitor 14 and/or remote monitoring device 18. The communication interface 30 may be formed as or may include, for example, one or more RF transmitters, one or more RF receivers, and/or one or more RF transceivers. Suppression system 16 may include its own power source, e.g., battery, (not shown) to allow performance of the functions described herein.

Suppression system 16 further has software 42 (which may include software application 46) stored internally in, for example, memory 40, or stored in external memory (e.g., database, storage array, network storage device, etc.) accessible by the suppression system 16 via an external connection. Software application 46 may include any software/program configured to perform the steps/processes of the present disclosure, e.g., triggering the release of suppression material 32. Further, software application 46 may run and/or be included directly as part of software 42 and/or the suppression system 16. Software application 46 may be virtualized and/or running outside the suppression system 16 and/or any of the components of the suppression system 16 such that a trigger signal is provided to cause the release of suppression material 32 when triggered to do so.

The processing circuitry 36 may be configured to control any of methods and/or processes described herein and/or to cause such methods, and/or processes to be performed, e.g., by the suppression system 16. Processor 38 corresponds to one or more processors 38 for performing the suppression system 16 functions described herein. The memory 40 is configured to store data and/or files, e.g., data/information generated by suppression unit 50 and/or other information described herein. In some embodiments, the software 42 may include instructions that, when executed by the processor 38 and/or processing circuitry 36, causes the processor 38 and/or processing circuitry 36 to perform the processes described herein with respect to the suppression system 16. For example, processing circuitry 36 of the suppression system 16 may include suppression unit 50 used to analyze date received from monitoring device 18 and/or event monitor 14 to trigger the release of suppression material 32. Further, processing circuitry 36 may include control unit 52 which may be configured to receive one or more inputs, and or produce one or more outputs (e.g., control signals) usable to control one or more components of system 10 (e.g., valves, pins, etc.)

The system 10 further includes monitoring device 18 including hardware 58. Monitoring device 18 can be any portable device such as a smart phone, tablet, laptop, etc., such as may be carried by the driver of a shipping vehicle carrying batteries 12, or the operator of a vehicle having batteries 12. Monitoring device 18 can also be any computing device, e.g., desktop computer, server, located at a monitoring center that is in communication with event monitor 14 and/or suppression system 16. The processing circuitry 66 may include a processor 68 and a memory 70. In particular, in addition to or instead of a processor, such as a central processing unit, and memory, the processing circuitry 66 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 68 may be configured to access (e.g., write to and/or read from) the memory 70, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory 70 may be configured as a storage device.

Hardware 58 of monitoring device 18 may include communication interface 60 enabling it to communicate directly/indirectly with any component/device of system 10. For example, communication interface 60 may be configured for setting up and maintaining at least a wireless/wired connection with any component/device of system 10 such as event monitor 14 and/or suppression system 16. The communication interface 60 may be formed as or may include, for example, one or more RF transmitters, one or more RF receivers, and/or one or more RF transceivers. Monitoring device 18 may include its own power source, e.g., battery, to allow performance of the functions described herein.

Monitoring device 18 further has software 82 (which may include software application 86) stored internally in, for example, memory 70, or stored in external memory (e.g., database, storage array, network storage device, etc.) accessible by the monitoring device 18 via an external connection. Software application 86 may include any software/program configured to perform the steps/processes of the present disclosure, e.g., monitoring parameter readings (e.g., temperature readings) received from event monitor 14, and generating and sending a message to suppression system 16 to cause the release of suppression material 32. Further, software application 86 may run and/or be included directly as part of software 82 and/or the monitoring device 18. Software application 86 may be virtualized and/or run outside the monitoring device 18 and/or any of the components of the monitoring device 18 such that a message is generated to cause the release of suppression material 32. Software application 86 may also include user interface 88 which operates to run a display (not shown) of monitoring device 18 to show data such as thermal data received from event monitor 14 to the user and/or to allow the user to cause the transmission of a message to suppression system 16 to release suppression material 32. In some embodiments, the user interface can show in indication that a pre-determined parameter (e.g., temperature) and/or rate of a parameter (e.g., rate of temperature) change within battery 12 has been reached and that processing circuitry 66 has automatically generated and transmitted a message to suppression system 16 triggering the release of suppression material 32.

The processing circuitry 66 may be configured to control any of methods and/or processes described herein and/or to cause such methods, and/or processes to be performed, e.g., by the monitoring device 18. Processor 68 corresponds to one or more processors 68 for performing the suppression system 16 functions described herein. The memory 70 is configured to store data and/or files, e.g., data/information generated by analysis/alert engine 74 and/or other information described herein. In some embodiments, the software 82 may include instructions that, when executed by the processor 68 and/or processing circuitry 66, causes the processor 68 and/or processing circuitry 66 to perform the processes described herein with respect to the monitoring device 18. For example, processing circuitry 66 of the monitoring device 18 may include analysis/alert engine 74 used to analyze data received from event monitor 14 and/or suppression system 16 regarding parameters associated with battery 12 (e.g., temperature and/or rate of temperature change) such as to trigger the release of suppression material 32 and/or to receive confirmation from suppression system 16 that suppression material 32 has been released. Further, processing circuitry 66 may include control unit 76 which may be configured to receive one or more inputs, and or produce one or more outputs (e.g., control signals) usable to control one or more components of system 10 (e.g., extractors, fans, etc.)

In some embodiments, the display of monitoring device 18 can indicate the battery 12 temperature in color, such as blue for a temperature that does not exceed a predetermined value (to indicate a normal battery temperature) and red for a temperature that exceeds a predetermined value (to indicate an abnormal battery temperature). Alarm icons can also be provided on the display of monitoring device 18, where different colors are used to indicate the absence or presence of an alarm (thermal event) condition. A vibration alert can also be provided to a user (monitoring device 18 can be equipped with a vibration element) when a thermal event is detected.

In sum, in operation, event monitor 14 monitors the parameters (e.g., temperature) of battery 12 (and/or internal space, container, etc.). The parameters such as temperature and/or rate of change of temperature and/or indication that either of these exceeds a predetermined value is provided to monitoring device 18 and/or suppression system 16. Monitoring device 18 receives the parameters from event monitor 14 and provides that information to a user, such as via a display. For example, if a thermal event is detected, e.g., temperature and/or rate of temperature change exceeds a predetermined value(s), monitoring device 18 sends a message to suppression system 16 to trigger the release of suppression material 32 over the battery 12 to thereby cause a reduction in the temperature of battery 12 and/or to avoid/suppress fire, explosion, etc.

As discussed above, suppression system 16 can be included in a packaging arrangement to allow batteries 12 to be shipped back to a manufacturer/recycler for safe recycling.

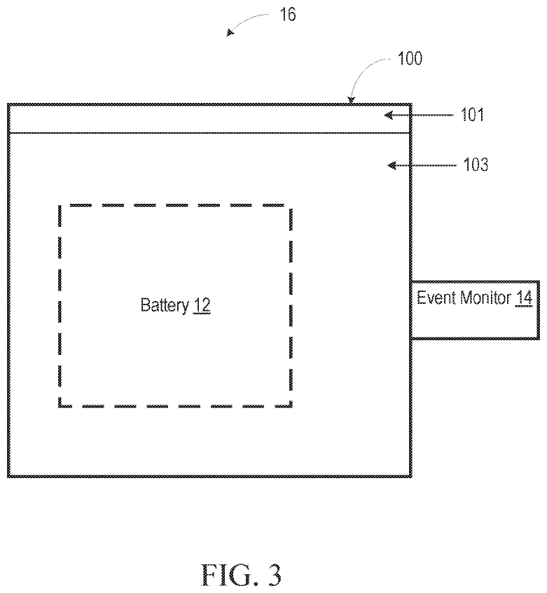

FIG. 3 shows an example suppression system 16. In this nonlimiting example, suppression system 16 comprises a container 100 (and/or event monitor 14). Container 100 comprises a container cover 101 and a container housing 103. Container cover 101 may be coupled to container housing 103, e.g., container cover 101 is releasably coupled to container housing such as to allow: (A) container 100 to be opened (by removing container cover 101); (B) battery 12 to be inserted in container housing 103; and (C) container 100 to be closed (by coupling container cover 101 to container housing 103). In some embodiments, after battery 12 is placed in container 100, container cover 101 is releasably sealed to container housing 103 such as to ship battery 12 to a recycling center. Event monitor 14 may be in proximity to, within, or coupled to container 100 of suppression system 16. Event monitor 14 may be configured to measure one or more parameters associated with the battery 12 and/or container 100 to detect one or more events such as a thermal runaway event.

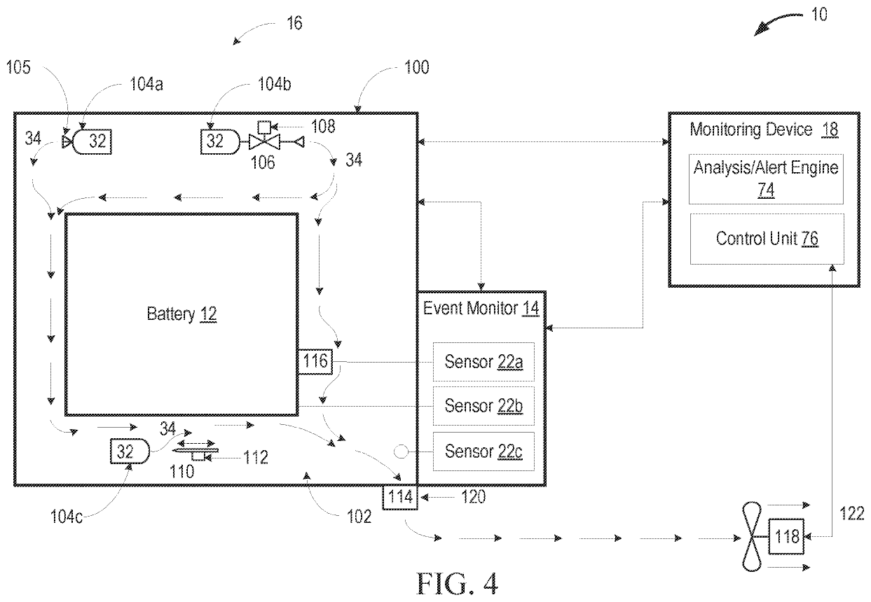

FIG. 4 shows an example system 10 according to one or more embodiments of the present disclosure. System 10 may comprise event monitor 14 and/or suppression system 16 and/or monitoring device 18. Suppression system 16 may comprise a container 100 arranged to receive, in internal space 102, a battery 12 and be sealed such as for shipping battery 12 to a recycling facility or to the battery manufacturer. Event monitor 14 may be in proximity to, within, or coupled (removably or permanently) to container 100 of suppression system 16. Container 100 may comprise one or more bags 104 (i.e., containers) arranged to contain suppression material 32. In a nonlimiting example, container 100 may comprise a bag 104a, 104b, and 104c. Each bag 104 may contain, and be arranged to release, suppression material 32 using one or more release mechanisms. Bag 104a may comprise bag seal 105. Bag seal 105 may be arranged to seal bag 104a such as to contain suppression material 32 within bag 104a when predetermined conditions are met. Bag seal 105 may further be arranged to open when the predetermined conditions are exceeded. For example, bag seal 105 may be arranged to open when a temperature associated with the bag 104a and/or with battery 12 and/or internal space 102 (e.g., a gas within the internal space) exceeds a predetermined parameter threshold (e.g., temperature threshold). When bag seal 105 opens suppression material 32 is discharged to internal space 102 (as discharged suppression material 34).

In some embodiments, bag 104b may be coupled to a valve 106 (and/or actuator). Valve 106 may be configured to receive a control signal 108 (e.g., from event monitor 14, suppression system 16, monitoring device 18) that triggers valve 106 to open and/or close (and/or throttle) valve 106. When valve 106 is open (and/or is throttling) suppression material 32 is discharged to internal space 102 (as discharged suppression material 34). In addition, container 100 may comprise pin 110 (and/or actuator) which may be arranged to travel in a first direction toward bag 104c such as to puncture bag 104c and to travel in a second direction (e.g., opposite the first direction) to retract pin 110, e.g., to allow suppression material 32 to be discharged (as discharged suppression material 34) to internal space 102 from punctured bag 104c (e.g., via a puncture on the bag caused by pin 110). Pin 110 may be configured to receive a control signal 112 (e.g., from event monitor 14, suppression system 16, monitoring device 18) to trigger pin 110 to travel and puncture bag 104c.

The discharged suppression material 34 may be arranged to flow within internal space and/or control a battery event, e.g., by absorbing heat such as emanated from battery 12 (and/or any other component of battery 12). For example, discharged suppression material 34 may physically contact battery 12 and provide a heat exchange function to cool down the battery 12 to a predetermined threshold. Further, container 100 may be sealed, where container 100 comprises a container cover 101 and a container housing 103 sealed to the container cover 101. Container 100 may further comprise one or more exhaust ports 114 which may be configured to open, close, or throttle such as to control contact time between discharged suppression material 34 (within internal space 102) and battery 12, e.g., based on a control signal 120.

Although bags 104a, 104b, and 104c are shown, the present disclosure is not limited as such, e.g., container 100 may comprise any quantity and/or types of bags 104. In some embodiments, the placement of bags 104 with respect to battery 12 (and its components) may be determined by the type, size, specifications of battery 12 (or battery components), suppression material characteristics, container characteristics, shipping information, recycling requirements, etc.

In a nonlimiting example, event monitor 14 comprises one or more sensors 22 (e.g., sensors 22a, 22b, 22c). Further, battery 12 may comprise exhaust port 116 which may be arranged to be in fluid communication with any other component of battery 12 such as a battery housing internal space, battery cells, battery management system, etc. Sensor 22a (e.g., temperature sensor, thermocouple, etc.) may be coupled to exhaust port 116 of battery 12 and may be configured to measure a parameter (e.g., temperature) of a gas present and/or leaving and/or entering exhaust port 116, e.g., to measure the temperature of the battery 12. Sensor 22b (e.g., another temperature sensor, thermocouple, etc.) may be coupled to one or more components of battery 12 (E.g., battery housing, cells) and measure a parameter (e.g., temperature) of the battery 12. Further, sensor 22c may be configured to measure a parameter associated with internal space 102 (e.g., a temperature or pressure of a gas within internal space 102, presence of a predetermined gas).

In another nonlimiting example, event monitor 14 (e.g., via one or more sensors 22) may be configured to determine that a parameter associated with battery 12 has reached or exceeded a parameter threshold (e.g., temperature threshold). Event monitor 14 may be configured to transmit a message to monitoring device 18 (and/or suppression system 16) where the message comprising parameter values, thresholds, and an indication indicating that the determined parameter has exceeded the parameter threshold. Monitoring device 18 may be configured to receive the message and use the parameter values, thresholds, and/or indication to determine whether an event associated with battery 12 (e.g., such a thermal event) has occurred or has a likelihood of occurring in a predetermined period of time. For example, monitoring device 18 may determine that a parameter (e.g., temperature) has reached or exceeded a parameter threshold. That is, monitoring device 18 may determine that an event has occurred. Monitoring device 18 may also determine a parameter differential (e.g., parameter at time 2 (p2)−parameter at time 1 (p1) and/or be used to determine a parameter differential over a period of time (t) (e.g., (p2−p1)/t. In addition, monitoring device 18 may be configured to determine a plurality of parameter values in time (e.g., a mathematical curve with respect to time).

Further, monitoring device 18 may be configured to determine that any one of the parameters, parameter values, parameter differentials, plurality of parameter values correspond to a battery event or condition (e.g., normal battery condition or an abnormal battery condition such as a thermal runaway). For example, monitoring device may receive one or more messages from event monitor 14 comprising data such as parameter values (e.g., temperature values) and determine a parameter differential (e.g., temperature rise per unit of time) and the determine that the parameter differential corresponds to an abnormal event has occurred or is likely to occur in battery 12 as the parameter differential exceeds a tolerance value when compared to a parameter differential that corresponds to a normal event.

Similarly, monitoring device 18 may be configured to compare a first curve (e.g., function, plot, mathematical curve, etc.) comprising a plurality of parameter values (e.g., sampled by event monitor 14) to a second curve, where the first curve corresponds to a normal state of battery 12 over time, and the second curve corresponds to an abnormal state of battery 12 over time. The comparison of curves may comprise determining a degree of similarity or deviation between the two curves (or portions thereof) to determine whether an abnormal state has occurred or is likely to occur.

In some embodiments, monitoring device 18 may be configured to transmit one or more control signals such as control signals 108, 112 to trigger the discharge of suppression material 32 (e.g., as discharged suppression material 34) to internal space 102 to cool down battery 12. Exhaust port 114 may be configured as a check valve (or any other valve controlled by monitoring device 18) to control the release of discharged suppression material 34 to the exterior of container 100. Monitoring device 18 may be further configured to detect that suppression material 32 has been discharged (e.g., based on information associated with a position of valve 106, pin 110, presence of discharged suppression material 34 (detected by sensor 22c), parameter values, etc.) and be configured to transmit a control signal 122 to fan 118 (e.g., extractor) arranged to extract discharged suppression material 34 to the exterior of system 10. In some embodiments, fan 118 may be arranged to extract battery gases (e.g., via exhaust ports 116, 114) such as based on a detection of a type of gas sensed by sensor 22. In some other embodiments, exhaust port 114 is ducted directly to the exterior and configure to release discharged suppression material 34 to the exterior, e.g., without the use of fan 118.

In another example, an owner of battery 12 decides to ship battery 12 for recycling. Battery 12 is inserted in container 100 (e.g., battery shipping container), which comprises one or more bags 104 (which may comprise one or more of bags 104 arranged as bag 104a, one or more bags 104 arranged as 104b, and/or one or more bags 104 arranged as bag 104c). Container 100 is releasably sealed (e.g., container cover is sealed to the container housing) and comprises exhaust port 114 (e.g., initially closed). That is, the inserted battery 12 is stored within internal space 102 of container 100. Sensor 22a of event monitor 14 measures the temperature of gas present in exhaust port 116 of battery 12 and/or sensor 22b measures the temperature of the bottom of the housing of battery 12. At time t1, a first temperature (T1) is measured by sensor 22a, which is consistent with a normal state of the battery 12. However, during shipping, e.g., time t2, the internal temperature of battery 12 increases at a first rate, e.g., corresponding to an impending thermal runaway event. Sensor 22a measures a second temperature (T2) at t2. Event monitor 14 transmits the measured temperatures to monitoring device 18, which determines a temperature differential per unit of time, i.e., (T2−T1)/(t2−t1), and compares the temperature differential with a base line value (e.g., associated with a normal event of battery 12) to determine whether suppression material 32 is to be discharged.

When container 100 comprises one or more bags arranged as bag 104, suppression material 32 is discharged by reaching the second temperature (i.e., triggers bag seal 105 to open). When container 100 comprises one or more bags arranged as either one of bags 104, 104c, the discharge of suppression material 32 may be triggered by monitoring device 18. That is, when the temperature differential per unit of time exceeds a predetermine threshold (e.g., associated with a current or impending thermal runaway event, monitoring device 18 transmits a control signal 108 or a control signal 112 to trigger the discharge of suppression material 32 (as discharged suppression material 34).

The presence of discharged suppression material 34 in internal space 102 may be detected by sensor 22c, and an indication of the presence of the discharged suppression material 34 may be transmitted monitoring device 18. The indication may be used as a confirmation of the discharge and to control presence time of the discharged suppression material 34 in internal space 102 (and/or contact with battery 12). For example, the time that the discharged suppression material 34 is in contact with battery 12 may be controlled by monitoring device 18 (and/or suppression system 16) and by changing the state of exhaust port 114 (e.g., closed, open, throttling). A closed exhaust port 114 may be used to extend the time that the discharged suppression material is in the internal space 102. An open exhaust port 114 may be used to expedite the release of the discharged suppression material 34 from the internal space 102. A throttling exhaust port 114 may be used to dynamically adjust the time that the discharged suppression material 34 is in contact with battery 12. The state of exhaust port 114 may be based on other parameters such as characteristics of the battery 12, suppression material 32, internal space 102, shipping conditions, etc.

Further, fan 118 may be energized by sending a control signal 122 to fan 118 based on information associated with control signals 108, 112, 120, presence detected by sensor 22c, temperatures measured by sensors 22a, 22b, etc. In addition, information corresponding to any of the parameters measured by sensors 22, control signals 108, 112, 120, 122, position or state corresponding to valve 106, pin 110, etc. may be displayed via user interface 88 shown in FIG. 2 to alert the driver of the truck where the battery 12 is being shipped. In some embodiments, user interface 88 may be used to manually trigger the release of suppression material 32.

In some embodiments, bags 104 are opened at different times (i.e., the bags are caused to discharge suppression material at different discharge stages) based on the measured parameters. For example, the first bag 104a may be opened at a first temperature (e.g., at a first time), and based on further measurements of temperature, the monitoring device 18 may determine that additional suppression material 32 may need to be discharged by the second bag 104b to further cool down the battery 12. Thus, monitoring device 18 triggers the second bag 104b to open at a second time. Similarly, the monitoring device 18 may determine that still more suppression material 32 may need to be discharged by the third bag 104c to cool down the battery 12. In such case, monitoring device 18 triggers the third bag 104c to open at a third time. That is, the times at which the discharge of suppression material 32 is discharged may be different and/or determined based on or more factors such as suppression material characteristics, battery characteristics, internal space characteristics, container characteristics, historical data and/or measurements (e.g., battery parameters), etc.

In some other embodiments, similar steps may be performed when battery 12 is being used in a vehicle, aircraft, infrastructure, etc.

In some embodiments, container 100 is closed (e.g., without being sealed) such that when suppression material 32 is discharged, the discharged suppression material 34 can be released to the exterior of container 100 by forcing its way between the container cover and housing out to the exterior (e.g., exhaust port 114 not being used). For example, container 100 may be closed by zipping the cover to its housing, where the discharged suppression material 34 may be released to the exterior via openings in the zipper and other openings between the container cover 101 and container housing 103.

In some embodiments, discharged suppression material 34 flows through one or more ducts to predetermined locations of battery 12, e.g., locations (e.g., cells) that are determined as having an increase in temperature, predetermined locations (e.g., cells) where thermal runaways are more likely to occur, etc.

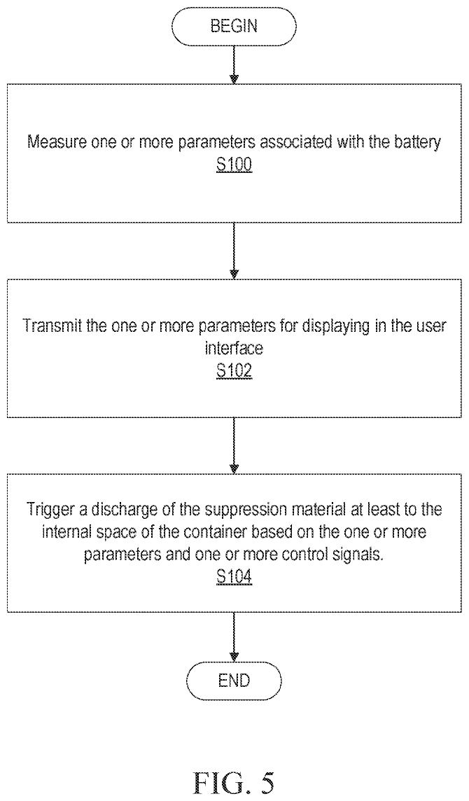

FIG. 5 shows a flowchart of an example process (e.g., implemented in system 10). The system comprises a container 100, one or more bags 104, and a monitoring device 18. The container 100 comprises an internal space 102 and being arranged to receive a battery 12 in the internal space 102 and the one or more bags 104. The one or more bags 104 comprise a suppression material 32 usable for controlling a battery event. The monitoring device 18 comprises a user interface 88. The method comprises measuring (Block S100) one or more parameters associated with the battery 12, transmitting (Block S102) the one or more parameters for displaying in the user interface 88, and triggering (Block S104) a discharge of the suppression material 32 at least to the internal space 102 of the container 100 based on the one or more parameters and one or more control signals.

In some embodiments, the method further comprises transmitting a message comprising the one or more parameters to the monitoring device 18; determining the battery event has occurred or a likelihood that the event will occur within a predetermined period of time based on one or both of the one or more parameters and a differential of the one or more parameters; and receiving from the monitoring device 18 the one or more control signals to trigger the discharge of the suppression material 32 of at least one of the one or more bags 104 based on the determination that the battery event has occurred or the likelihood that the event will occur within the predetermined period of time.

In some other embodiments, the one or more bags 104 comprise one or both of a first bag 104a and a second bag 104b. The one or more parameters comprise a first parameter and a second parameter. The container 100 comprises one or both of a valve 106 coupled to the first bag 104a and a pin arranged to puncture the second bag 104b. The method further comprises one or both of opening the valve 106 when the first parameter reaches or exceeds a first parameter threshold to discharge the suppression material 32 of the first bag 104a and puncturing the second bag 104b when the second parameter reaches or exceeds a second parameter threshold to discharge the suppression material 32 of the second bag 104b.

In some embodiments, the method comprises discharging the suppression material 32 of the first bag 104a and the second bag 104b during a first discharge stage and a second discharge stage, respectively, based on the one or more parameters.

In some other embodiments, one or more of the method further comprises receiving a first control signal 108 of the one or more control signals, opening the valve 106 to discharge the suppression material 32 of the first bag 104a based on the first control signal 108, receiving a second control signal 112 of the one or more control signals, and triggering the pin to puncture the second bag 104b to discharge the suppression material 32 of the second bag 104b based on the second control signal 112; the opening of the valve 106 is associated with a first exposure period in which the discharged suppression material 34 is exposed to the battery 12; and the puncturing of the second bag 104b is associated with a second exposure period in which the discharged suppression material 34 is exposed to the battery 12.

In some embodiments, the container 100 comprises an exhaust port arranged to receive a third control signal 120 of the one or more control signals, and the method further comprises receiving a third control signal 120 and triggering the exhaust port to control a release of the discharged suppression material 34 from the internal space 102 based on the third control signal 120. The release of the discharged suppression material 34 is controlled by one or more of opening the exhaust port, closing the exhaust port, throttling the exhaust port based on the one or more parameters.

In some other embodiments, the controlling of the release of the discharged suppression material 34 by the exhaust port controls a third exposure period in which the discharged suppression material 34 is exposed to the battery 12.

In some embodiments, the suppression material 32 is arranged to flow through the internal space 102 and absorb heat from one or more of the battery 12, the internal space 102, and the container 100.

In some other embodiments, the system further comprises a fan 118 configured to receive a fourth control signal 122 of the one or more control signals, and the method further comprises transmitting the fourth control signal 122 and energizing the fan 118 based on the fourth control signal 122 to extract the discharged suppression material 34 from the system.

In some embodiments one or more of the one or more parameters include one or more of a battery temperature, a pressure associated with the internal space 102, a presence of the suppression material 32; the battery event is a thermal runaway event; and the discharged suppression material 34 controls the thermal runaway event at least by causing the battery temperature to be less than a predetermined temperature threshold.

One or more embodiments of the present disclosure are beneficial at least because a state such as a thermal runaway associated with battery 12 can be detected and one or more actions performed to address the state, e.g., by automatically releasing suppression material 32 to cool down battery 12 and prevent or control potential damage and injury.

It is understood that all specification values shown and described herein are non-limiting examples for implementations of batteries 10 and cells 14 constructed in accordance with the principles of the disclosure provided herein. It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and following claims.

1. A suppression system comprising:
a container having an internal space arranged to receive a battery, the container comprising:
one or more bags comprising a suppression material, the one or more bags being arranged to discharge the suppression material at least to the internal space of the container based on one or more parameters and one or more control signals, the discharged suppression material being usable to control a battery event; and
an event monitor comprising one or more sensors configured to measure the one or more parameters, the measured one or more parameters being transmittable by the event monitor to a monitoring device and triggering the one or more control signals.

2. The suppression system of claim 1, wherein the one or more bags comprise one or both of:
a first bag, the one or more parameters comprise a first parameter, and the container comprises a valve coupled to the first bag and configured to open when the first parameter reaches or exceeds a first parameter threshold to discharge the suppression material of the first bag; and
a second bag, the one or more parameters comprise a second parameter, and the container comprises a pin arranged to puncture the second bag when the second parameter reaches or exceeds a second parameter threshold to discharge the suppression material of the second bag.

3. The suppression system of claim 2, wherein the suppression material of the first bag and the second bag are discharged during a first discharge stage and a second discharge stage, respectively, based on the one or more parameters.

4. The suppression system of claim 2, wherein one or more of:
the valve is configured to receive a first control signal of the one or more control signals that triggers the valve to open to discharge the suppression material of the first bag;
the opening of the valve is associated with a first exposure period in which the discharged suppression material is exposed to the battery;
the pin is configured receive a second control signal of the one or more control signals that triggers the pin to puncture the second bag to discharge the suppression material of the second bag; and
the puncturing of the second bag is associated with a second exposure period in which the discharged suppression material is exposed to the battery.

5. The suppression system of claim 1, wherein the container comprises an exhaust port arranged to receive a third control signal of the one or more control signals that triggers the exhaust port to control a release of the discharged suppression material from the internal space, the release of the discharged suppression material being controlled by one or more of opening the exhaust port, closing the exhaust port, throttling the exhaust port based on the one or more parameters.

6. The suppression system of claim 5, wherein the controlling of the release of the discharged suppression material by the exhaust port controls a third exposure period in which the discharged suppression material is exposed to the battery.

7. The suppression system of claim 1, wherein the suppression system further comprises first processing circuitry and a first communication interface, one or both of:
the first processing circuitry being configured to determine the one or more control signals based on the one or more parameters; and
the first communication interface being configured to receive the one or more control signals based on the one or more parameters.

8. The suppression system of claim 1, wherein the event monitor further comprises a second communication interface configured to transmit the measured one or more parameters, the transmission of the measured one or more parameters triggering transmission of the one or more control signals.

9. The suppression system of claim 1, wherein the suppression material is arranged to flow through the internal space and absorb heat from one or more of the battery, the internal space, and the container.

10. The suppression system of claim 1, wherein one or more of:
the one or more parameters include one or more of a battery temperature, a pressure associated with the internal space, and a presence of the suppression material;
the battery event is a thermal runaway event; and
the discharged suppression material controls the thermal runaway event.

11. A system comprising:
a suppression system comprising:
a container having an internal space arranged to receive a battery, the container comprising:
one or more bags comprising a suppression material, the one or more bags being arranged to discharge the suppression material at least to the internal space of the container based on one or more parameters and one or more control signals, the discharged suppression material being usable to control a battery event;
an event monitor comprising:
one or more sensors configured to measure the one or more parameters, the measured one or more parameters being transmittable by the event monitor to a monitoring device and triggering the one or more control signals; and
the monitoring device in communication with the event monitor and comprising:
a user interface configured to display the one or more parameters.

12. The system of claim 11, wherein one or more of:
the suppression system comprises first processing circuitry configured to:
trigger the discharge of the suppression material of at least one of the one or more bags;
the event monitor comprises second processing circuitry in communication with the one or more sensors and being configured to:
cause transmission of a message comprising the one or more parameters to the monitoring device;
the monitoring device comprises third processing circuitry configured to one or more of:
receive the message;
determine the battery event has occurred or a likelihood that the event will occur within a predetermined period of time based on one or both of the one or more parameters and a differential of the one or more parameters; and
cause transmission of the one or more control signals to the suppression system to trigger the discharge of the suppression material of at least one of the one or more bags based on the determination that the battery event has occurred or the likelihood that the event will occur within the predetermined period of time.

13. The system of claim 11, wherein the one or more bags comprise one or both of:
a first bag, the one or more parameters comprise a first parameter, and the container comprises a valve coupled to the first bag and configured to open when the first parameter reaches or exceeds a first parameter threshold to discharge the suppression material of the first bag; and
a second bag, the one or more parameters comprise a second parameter, and the container comprises a pin arranged to puncture the second bag when the second parameter reaches or exceeds a second parameter threshold to discharge the suppression material of the second bag.

14. The system of claim 13, wherein the suppression material of the first bag and the second bag are discharged during a first discharge stage and a second discharge stage, respectively, based on the one or more parameters.

15. The system of claim 13, wherein one or more of:
the valve is configured to receive a first control signal of the one or more control signals that triggers the valve to open to discharge the suppression material of the first bag;
the opening of the valve is associated with a first exposure period in which the discharged suppression material is exposed to the battery;
the pin is configured receive a second control signal of the one or more control signals that triggers the pin to puncture the second bag to discharge the suppression material of the second bag; and
the puncturing of the second bag is associated with a second exposure period in which the discharged suppression material is exposed to the battery.

16. The system of claim 11, wherein the container comprises an exhaust port arranged to receive a third control signal of the one or more control signals that triggers the exhaust port to control a release of the discharged suppression material from the internal space, the release of the discharged suppression material being controlled by one or more of opening the exhaust port, closing the exhaust port, throttling the exhaust port based on the one or more parameters.

17. The system of claim 16, wherein the controlling of the release of the discharged suppression material by the exhaust port controls a third exposure period in which the discharged suppression material is exposed to the battery.

18. The system of claim 11, wherein the suppression material is arranged to flow through the internal space and absorb heat from one or more of the battery, the internal space, and the container.

19. The system of claim 11, wherein the system further comprises a fan configured to receive a fourth control signal of the one or more control signals, and the third processing circuitry is further configured to:
cause transmission of the fourth control signal triggering the fan to be energized and to extract discharged suppression material from the system.

20. The system of claim 11, wherein one or more of:
the one or more parameters include one or more of a battery temperature, a pressure associated with the internal space, a presence of the suppression material;
the battery event is a thermal runaway event; and
the discharged suppression material controls the thermal runaway event at least by causing the battery temperature to be less than a predetermined temperature threshold.

21.-30. (canceled)
